(19) United States
(12) Patent Application Publication
(10) Pub. No.: US 2005/0284231 A1
(43) Pub. Date: Dec. 29, 2005

(54) Stress/extension-measuring sensor and method for measuring stress/expansion

(76) Inventors: Werner Zimmerman, Putzbrunn (DE); Peter Janker, Riemerling (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/523,813

(22) PCT Filed: Aug. 5, 2003
(86) PCT No.: PCT/DE03/02648

§ 371 Date: Aug. 10, 2005

(30) Foreign Application Priority Data
Aug. 6, 2002 (DE) 102 36 051.0

(51) Int. Cl. F16B 31/02

(52) U.S. Cl. 73/761

(57) ABSTRACT

A stress/strain measuring sensor for the continuous monitoring of stress/strain conditions, especially in screwed bolts, along with a corresponding measuring process is disclosed. An arrangement, and a corresponding method, are provided that are uncomplicated and easy to implement, and enable a continuous monitoring of stress/strain conditions. This is attained using a sensor (1) that comprises a first inductor (3) and at least one additional element (2), which comprises at least one pressure-dependent first impedance (5) or a second impedance (5′) and a second inductor (3′), wherein the second impedance (5′) and/or the second inductor (3′) are pressure-dependent, so that when the amount of pressure applied to the element (2) changes, the resonant frequency of an electromagnetic resonating circuit (3, 5; 3′, 5′) that is formed by impedance (5, 5′) and inductor (3, 3′) changes.

### BACKGROUND AND SUMMARY OF THE INVENTION

The present invention relates to a stress/strain measuring sensor for the continuous monitoring of stress/strain conditions, especially in screwed bolts, and a corresponding measuring process. The invention is designed for use, for instance, in maintenance work for the purpose of checking stress/strain conditions so that, for example, torque levels of screwed bolts can be easily monitored and adjusted.

In relation to this area of application, so-called torque keys are known from the state of the art, which operate, for example, using ultrasound sensors.

Also known are stress sensors in which piezoelectric materials are used. In such cases, the known piezoelectric effect is utilized so that, when force is applied to the piezoelectric material via electric displacement, surface charges are created. A sensor of this type is described, for example, in WO 99/26046.

The problem with this, however, is that the electrical charge separation that occurs as a result of exposure to mechanical deformation exists for only a short time, making continuous measurement impossible. Furthermore, charge amplification is usually necessary, as is described in WO 99/26046, in order to convert the piezoelectrically generated charges to a proportional stress level.

It is thus the object of the present invention to create a stress/strain measuring sensor and a corresponding process, which are uncomplicated and easy to use, and which will enable a continuous monitoring of stress/strain conditions.

The object is attained with a stress/strain measuring sensor that includes a first inductor and at least one other element, which comprises at least one pressure-dependent first impedance or a second impedance and a second inductor, wherein the second impedance and/or the second inductor are pressure-dependent, so that when the pressure applied to the element is changed, the resonant frequency of an electromagnetic resonating circuit formed by impedance and inductor changes.

What is essential in this connection is that, by using pressure-dependent electromagnetic components and by arranging them in relation to an electromagnetic resonating circuit, the resonant frequency of said circuit is utilized to determine strain/stress conditions. In principle, complementary components (impedance, inductor, etc.) having corresponding pressure-dependent properties can be used for this. In the case of a pressure-dependent impedance, e.g., this would be an inductor, and vice-versa.

In contrast to the direct measurement of short-term charge separations—as is customarily done in the state of the art—here a continuous measurement can be achieved via the measurement of varying resonant frequencies. The utilization of simple, pressure-dependent electrical components represents a particularly simple and effective measuring method and enables flexible embodiments. Thus, the invention is simple in design and easy to handle, also because no separate power supply is necessary. In addition, only passive components are used.

According to a first embodiment, the sensor comprises a first inductor along with an additional element that has at least one pressure-dependent first impedance. The pressure-dependent first impedance, with the first inductor, forms an electromagnetic resonating circuit, the resonant frequency of which changes when pressure is applied to the element. Of course, the element may also comprise additional electromagnetic components (resistors, inductors, etc.) without altering this underlying principle.

Expediently, in the first embodiment the element is comprised entirely or partially of a dielectric material, the permeability of which changes with the application of pressure. Advantageously this material can be well integrated into existing assemblies because it is lightweight and small.

According to a preferred embodiment, the additional element of the sensor comprises at least one pressure-dependent second impedance and a second inductor, wherein the pressure-dependent impedance and the second inductor are connected in parallel and form an electromagnetic resonating circuit, so that the resonant frequency of said circuit is shifted as the application of pressure to the element changes.

Expediently, the element in this case is comprised of piezoelectric or magnetostrictive material. In addition, any type of materials may be used that will effect a load- or pressure-dependent electromagnetic coupling. These materials or substances can be well integrated into existing assemblies because they are lightweight and their dimensions are small.

According to a particularly preferred embodiment, the sensor is designed essentially as a foil on which the first inductor is arranged, along with contact surfaces for contacting the additional element. A foil-type embodiment of this kind is also advantageously characterized by a lightweight design and small dimensions.

In addition, it is especially advantageous that the foil-type sensor encompasses the additional element at least partially in the area of the contact surfaces. By bending or folding the foil-type sensor, the contacting of the additional element can be accomplished in a multitude of ways without difficulty.

It is further advantageous that the section of the foil-type sensor that is equipped with the first inductor projects out above the additional element, which facilitates the coupling of measuring or testing devices.

It is particularly advantageous that the first inductor serves as both coupling an d decoupling element, so that the first inductor serves on one hand to activate the given electromagnetic resonating circuit and on the other hand to measure the resonant frequency of the given electromagnetic resonating circuit. In this manner a contact-free coupling is possible both in the activation of the electromagnetic resonating circuit and in sampling the strain/stress condition. The sensor thus requires no external leads.

In sampling the stress/strain condition it is expedient to use a transceiver as the testing device, which can be coupled to the sensor via the first inductor.

According to a particularly preferred embodiment, the additional element is integrated into a flat washer, which can be positioned between a mounting assembly and a structure that is attached thereto. In this embodiment as well, it is advantageous that the additional element is contacted, for example, via a foil-type section, and that the section of the foil-type sensor that is equipped with the first inductor projects out over the flat washer, so that a testing device can be easily coupled to it.

According to an alternative embodiment, it is expedient to integrate a second element into the flat washer as a comparator element. This has the advantage that, in the determination of stress/strain conditions, the effects of temperature or aging can be compensated for, as only changes in the resonant frequency are registered.

The object stated above is further attained with a method for measuring stress/strain, which is characterized pursuant to the invention in that at least one element of a sensor with a first inductor, which comprises at least one pressure-dependent first impedance or a second impedance and a second inductor, wherein the second impedance and/or the second inductor are pressure-dependent, is arranged between a mounting assembly and a structure that is connected to the mounting assembly such that when the pressure that is applied to the element changes, the resonant frequency of an electromagnetic resonating circuit that is formed by impedance and inductor is changed.

What is expedient here is that the element is compressed with the application of pressure, and when the amount of pressure applied is decreased, the compression is released, and that the appropriate electromagnetic resonating circuit is activated via the first inductor.

It is further advantageous that the measurement of the resonant frequency of the electromagnetic resonating circuit is accomplished via a contact-free coupling to the first inductor.

According to an alternative embodiment, it is expedient, using a second element, to perform a comparative measurement to compensate for the effects of temperature or aging, as only a change in the pressure/stress conditions or the resonant frequency is registered.

The invention is appropriate for use, for example, in adjusting torque in screwed bolts and thus replaces known torque keys. The invention can be used, e.g., in maintenance work on aircraft, helicopters or other modes of transportation.

### BRIEF DESCRIPTION OF THE DRAWING FIGURES

Below, the invention will be described in greater detail with reference to the attached diagrams. In these:

FIG. 1 shows a schematic representation of the sensor specified in the invention for determining the stress/strain conditions of a screwed bolt;

FIG. 2 shows a plan view of a foil-type sensor;

FIG. 3 shows a perspective view of a foil-type sensor;

FIGS. 4, 4a-c show the analogous electric circuit of the sensor according to various embodiments;

FIG. 5 shows a representation of the resonant frequency under different levels of pressure; and

FIG. 6 shows the resonant frequency as a function of the application of pressure.

### DETAILED DESCRIPTION

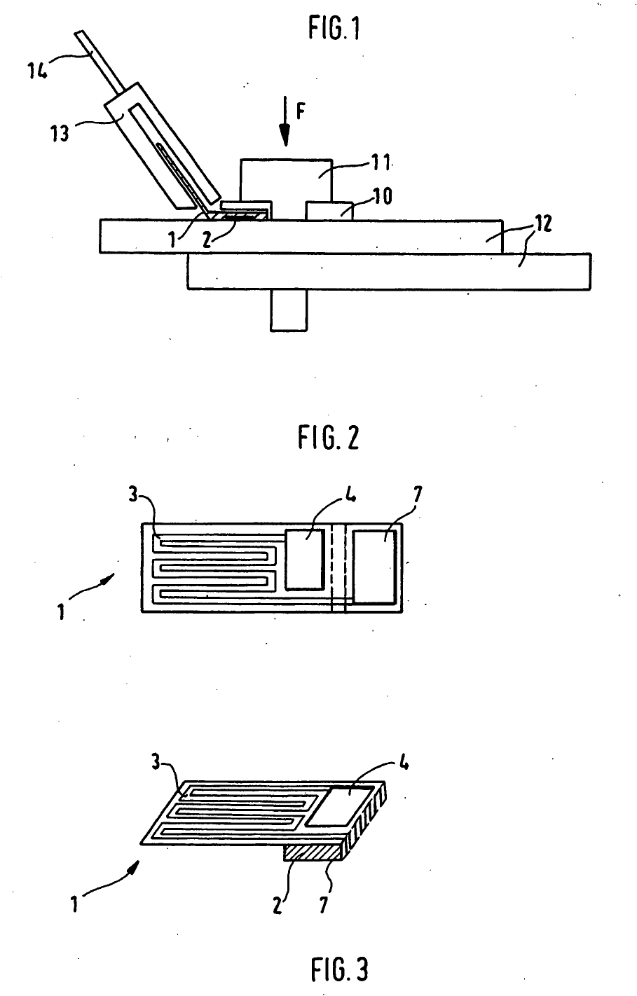

FIG. 1 shows a schematic representation of the sensor specified in the invention for determining the stress/strain conditions of a screwed bolt. In FIG. 1 the sensor is indicated by the number 1 and is integrated into a flat washer 10. The flat washer 10 with the integrated sensor 1, hereinafter also referred to as the modified flat washer, is positioned between a bolt 11 and a structure 12 that is connected to said bolt. Further, a testing device 13 (e.g. a transceiver) is coupled, contact-free, to the sensor 1, which will be described in greater detail further below. Via a data line 14 the data obtained from the transceiver are passed on to an evaluation unit (not illustrated here).

The sensor 1 comprises a dielectric, piezoelectric or magnetostrictive element 2, which is indicated only schematically in FIG. 1. In principle, materials with load- or pressure-dependent electromechanical couplings may be used. In FIG. 1 the element 2 is integrated into the flat washer 10 in such a way that its surface is arranged essentially perpendicular to the direction F in which pressure is applied. The element 2 is contacted via a foil-type section of the sensor 1, as is shown in FIGS. 2 and 3.

FIG. 2 shows a plan view of a foil-type sensor 1, in which the element 2 is not visible. On the foil-type sensor a first inductor 3 is applied in a meandering form and is connected to corresponding contact surfaces 4 and 7. The contact surfaces 4, 7 serve to contact the element 2. To this end, the foil-type sensor as shown in FIG. 2 is bent around the fold or break point, indicated here by a dashed line, in order to contact the element 2, as shown in FIG. 3. In this, ordinarily the section of the foil-type sensor 1 that is equipped with the first inductor 3 projects out over the element 2, in order to facilitate a coupling of measuring devices (see FIG. 1). The sensor arrangement shown in FIG. 3 is integrated into the flat washer 10, as described above. Of course, the sensor arrangement may also be integrated into other spacing or intermediate components.

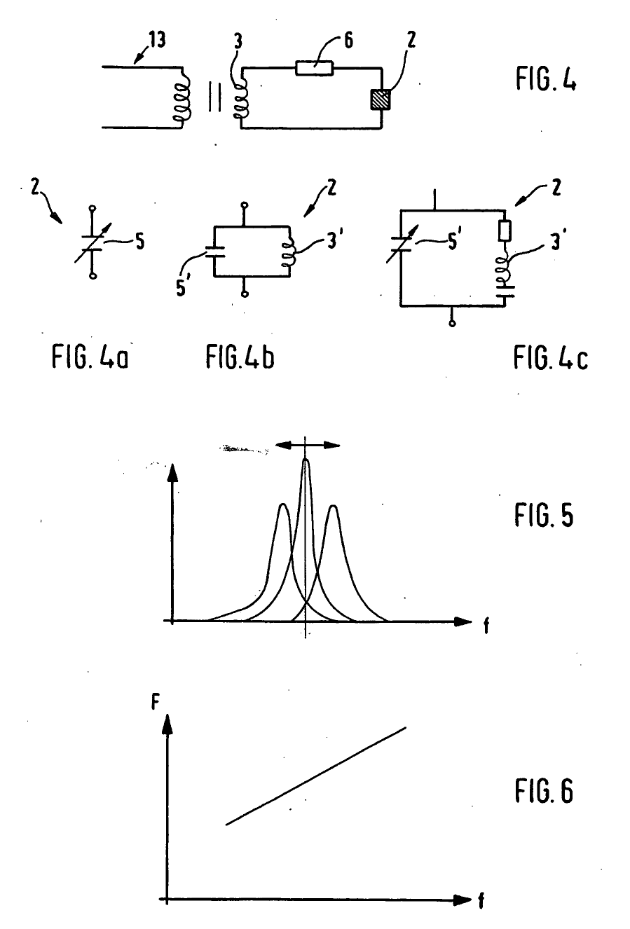

FIG. 4 shows the analogous electric circuit of the sensor 1 in various embodiments. In this, the electrical element and the first inductor are indicated by the same reference numbers as in the previous diagrams. In addition, in FIG. 4 the line resistor is indicated by the number 6. Of course, other electrical components may also be included in the analogous electric circuit, without affecting the underlying principle of the invention.

The electrical component 2 can be designed differently. According to a first embodiment (4a) the element 2 comprises a condenser with a pressure-dependent impedance and is indicated below by the number 5. This is implemented, for example, with a dielectric element, the permeability of which changes with the application of pressure. The pressure-dependent impedance 5, together with the first inductor 3, forms an electromagnetic LC resonating circuit, the resonant frequency of which changes with the application of pressure.

According to a second embodiment (4b), the element 2 itself comprises at least one impedance and an inductor connected to it in parallel, which are indicated in FIG. 4b similarly by the numbers 5′ and 3′. In practical terms this is implemented using piezoelectric and/or magnetostrictive elements 2. In this embodiment, the electromagnetic resonating circuit, the resonant frequency of which changes with the application of pressure, is formed by the impedance 5′ and the inductor 3′. In addition, the impedance 5′ and/or the inductor 3′ can be pressure-dependent. Of course, with this embodiment as well, other parallel or series-connected components may be considered, without affecting the fundamental principle.

According to a particularly preferred embodiment (FIG. 4c), the element 2 is made of a piezoelectric material. As is known, a piezoelectric element, due to its own material state, possesses a mechanical resonance and an inherent capacitance, and can be illustrated by the analogous circuit shown in FIG. 4c. Consequently, here, as in the second embodiment shown in FIG. 4b, the electromagnetic LC resonating circuit is formed by the impedance and/or inductor, also indicated by the numbers 5′ and 3′, so that with the pressure-dependence of the impedance 5′ a shifting of the resonant frequency with the application of pressure to the piezoelectric element 2 takes place. With the application of pressure, the piezoelectric element 2 experiences a compression, which results in a corresponding charge shift (“piezoelectric effect”) and, with the material-based pressure dependence of the absolute permittivity, thus results in a shift in the resonant frequency.

In the above-described embodiments, the element 2 experiences compression with the application of pressure, and with a decrease in the amount of pressure applied, experiences a corresponding release of said compression. This in turn leads, as described above, to a measurable resonant frequency shift, so that the condition “bolt stressed” or “bolt unstressed” can be continuously monitored.

An application of pressure to the element 2 thus effects, e.g., a shift in the resonant frequency to higher frequencies, as is illustrated, for example, in FIG. 5 and FIG. 6. When the amount of pressure applied is decreased, the resonant frequency shifts proportionally to lower frequencies. Of course, an arrangement may also be selected in which this method is reversed.

It should further be noted that the activation of the present electromagnetic resonating circuit is accomplished via the first inductor 3, which thus serves as the coupling element. This can be accomplished contact-free (e.g. capacitively). However, the first inductor 3 serves at the same time as an antenna or decoupling element for measuring the resonant frequency. Here again, the measurement is preferably conducted contact-free.

According to a further embodiment (not illustrated here), a second element (e.g. made of dielectric, piezoelectric or magnetostrictive material) is arranged in the flat washer 10 in order to allow comparative measurements. To accomplish this, a metrological bridge is constructed of one mechanically stressed and one mechanically unstressed element 2, whereby the relative displacement of the resonant frequency can be determined. An arrangement of this type or comparative measurement enables, for example, a compensation for the effects of temperature, aging, or similar factors.

Finally, it should be noted that in principle, a series of different possible arrangements of electromagnetic components to form corresponding electromagnetic resonating circuits is conceivable, which enable a stress/strain measurement that can be conducted on the basis of the above principle. The above-described embodiments are only exemplary embodiments, and are not intended to limit the scope of the object of the present invention.

1. Stress/strain measuring sensor for the continuous monitoring of stress/strain conditions, wherein the sensor comprises:
a first inductor; and
at least one other element which is made of piezoelectric or magnetostrictive material, and which comprises at least one pressure-dependent first impedance or a second impedance and a second inductor,
wherein the second impedance and/or the second inductor are pressure-dependent, so that when the amount of pressure being applied to the at least one other element is changed, the resonant frequency of an electromagnetic resonating circuit that is formed by impedance and inductor changes.

2. Stress/strain measuring sensor according to claim 1, wherein the at least one other element comprises at least the pressure-dependent first impedance, and wherein the first inductor and the first impedance form the electromagnetic resonating circuit.

3. Stress/strain measuring sensor according to claim 2, wherein the at least one other element is made entirely or partially of a dielectric material.

4. Stress/strain measuring sensor according to claim 1, wherein the at least one other element comprises at least the pressure-dependent second impedance and the second inductor, wherein the pressure-dependent second impedance and the second inductor are connected in parallel and form the electromagnetic resonating circuit, so that when the amount of pressure being applied to the at least one other element changes, the resonant frequency of the circuit shifts.

5. Stress/strain measuring sensor according to claim 1 wherein the sensor is essentially a foil, on which the first inductor and contact surfaces for contacting the element are arranged.

6. Stress/strain measuring sensor according to claim 5, wherein the foil-type sensor encompasses the at least one other element at least partially in the area of the contact surfaces.

7. Stress/strain measuring sensor according to claim 5 wherein the section of the foil-type sensor that is equipped with the first inductor projects out over the element.

8. Stress/strain measuring sensor according to claim 1 wherein the first inductor serves as both coupling and decoupling element.

9. Stress/strain measuring sensor according to claim 1 wherein a testing device for checking the stress/strain condition is coupled, contact-free, to the sensor via the first inductor.

10. Stress/strain measuring sensor according to claim 1 the at least one other element is integrated into a flat washer.

11. Stress/strain measuring device according to claim 10, wherein a second element is arranged in the flat washer to allow comparative measurement to compensate for the effects of temperature and aging.

12. Stress/strain measuring sensor according to claim 10 wherein the flat washer is positioned between a mounting assembly and a structure that is connected to said mounting assembly.

13. Method for stress/strain measurement, comprising the act of:
arranging, between a mounting assembly and a structure connected to the mounting assembly, at least one element, made of piezoelectric or magnetostrictive material, of a sensor with a first inductor, which comprises at least one pressure-dependent first impedance or a second impedance and a second inductor, wherein the second impedance and/or the second inductor are pressure-dependent, such that when the amount of pressure applied to the at least one other element changes, the resonant frequency of an electromagnetic resonating circuit that is formed by impedance and inductor is changed.

14. Method for stress/strain measurement according to claim 13, wherein the element is compressed when pressure is applied, and is released from said compression as the amount of pressure applied is decreased.

15. Method for stress/strain measurement according to claim 13 wherein the electromagnetic resonating circuit projects out over the first inductor.

16. Method for stress/strain measurement according to claim 13, wherein the measurement of the resonant frequency of the electromagnetic resonating circuit is accomplished via a contact-free coupling to the first inductor.

17. Method for stress/strain measurement according to claim 13, wherein a comparative measurement is conducted using a second element, so that shifts in the resonant frequency can be identified.
